(19) United States
(12) Patent Application Publication
(10) Pub. No.: US 2026/0285626 A1
(43) Pub. Date: Sep. 24, 2026

(54) PORTABLE LOADING AND UNLOADING APPARATUS FOR MOBILE VEHICLES

(71) Applicant: NATIONAL CHUNG SHAN INSTITUTE OF SCIENCE AND TECHNOLOGY, Taoyuan City (TW)

(72) Inventors: Shen-Jung Wang, Taoyuan City (TW); Yi-Yen Tseng, Taoyuan City (TW); Dai-Li Jheng, Taoyuan City (TW); Yu-Chen Wu, Taoyuan City (TW); Guan-Ting Liou, Taoyuan City (TW)

(73) Assignee: NATIONAL CHUNG SHAN INSTITUTE OF SCIENCE AND TECHNOLOGY, Taoyuan City (TW)

(21) Appl. No.: 19/393,634

(22) Filed: Nov. 19, 2025

(30) Foreign Application Priority Data
Mar. 21, 2025 (TW) 114110750

(51) Int. Cl. B65G 69/30

(52) U.S. Cl. CPC B65G 69/30

(57) ABSTRACT

The present disclosure provides a portable loading and unloading apparatus for a mobile vehicle, including a plurality of stacked bearing units, configured to bear a heavy object; two long ramps, disposed on the stacked bearing units, where the long ramps include a plurality of ramp units; and a safety auxiliary unit, including a plurality of auxiliary plates and a plurality of side baffles, where the plurality of auxiliary plates are disposed between the two long ramps, and the side baffles are disposed on a side position of the two long ramps. In this way, the portable loading and unloading apparatus for the mobile vehicle that is portable, quickly assembled, and applicable to different environments is manufactured.

### CROSS-REFERENCE TO RELATED APPLICATION

This non-provisional application claims priority under 35 U.S.C. § 119(a) on Patent Application No(s). 114110750 filed in Taiwan, R.O.C. on Mar. 21, 2025, the entire contents of which are hereby incorporated by reference.

### BACKGROUND OF THE INVENTION

### Field of the Invention

The present disclosure relates to a loading and unloading apparatus for a mobile vehicle, and in particular, to a portable loading and unloading apparatus for a heavy weapon mobile vehicle.

### Description of the Related Art

A heavy weapon, for example, a mobile vehicle such as a tank and a large military vehicle, has an extremely high requirement on a structure and a function of a loading and unloading apparatus during transportation. This type of transportation mainly involves two cases: First, a train is used to perform long-distance strategic mobilization; and second, a flatbed trailer is used for transference on a road or a battlefield. Railway transportation has an advantage of a moving speed, but has obvious limitations, including poor mobility. Because a heavy vehicle can only be transferred from a fixed railway platform to the battlefield, an additional loading and unloading apparatus is needed to achieve optimal railway transportation efficiency.

For Taiwan, the military parks heavy weapon equipment on a railcar on a railway freight platform, and performs an operation of transporting a large quantity of military vehicles by using an existing railway transportation system. However, how to park heavy and large vehicle equipment (for example, large vehicles such as the tank and a gun carrier) on the railcar on the railway freight platform with a height becomes an important issue. Under normal circumstances, a loading and unloading operation of getting on or off the railcar on the platform that is performed on the mobile vehicle, such as the large military vehicle is completed by using a freight end platform of the railway. The terminal platform is a ramp at an end edge of the platform that connects the ground of an access road with the platform. Because the ramp is a lane fixedly disposed at an end of the platform, the ramp is referred to as the end platform. The military vehicle needs to travel on a ramp lane to implement an operation task of getting on or off the railcar. However, because a design of the end platform is based on an existing platform infrastructure, a quantity and a location of the platform are limited, and an entire loading and unloading operation can be completed only on a particular platform.

In the related art, the ramp on which the mobile vehicle such as the heavy weapon equipment travels is generally made from a steel support bracket to bear a huge pressure, and a wheel contact area is covered by two parallel tracks. In addition, the middle of the ramp is kept vacant, to reduce material consumption and a weight of a structure. In addition, to ensure a grip of the heavy weapon equipment (such as the tank) on the ramp, an anti-slip pattern or a rubber coating layer is disposed on a surface of the ramp. However, these technologies have some limitations, for example, when the ramp is relatively long or a load is excessively high, structural stability and service life of the ramp are easily affected. In addition, an alignment problem in a loading process also leads to many accident risks when the large vehicle is ascending the ramp.

As described above, in the face of various task requirements during war, the mobile vehicle such as the heavy equipment needs to be capable of being loaded and unloaded at any location, and the loading and unloading of the mobile vehicle such as the heavy weapon cannot be completed only on a railway platform. Therefore, currently, a mobile loading and unloading apparatus urgently needs to be manufactured, so that the loading and unloading operation of getting on or off the railcar on the railway platform or the flatbed trailer can be completed on the mobile vehicle such as the heavy weapon equipment.

### BRIEF SUMMARY OF THE INVENTION

To improve disadvantages of the related art, the present disclosure provides a portable loading and unloading apparatus for a mobile vehicle, which integrates a plurality of stacked bearing units, a plurality of ramp units, a safety auxiliary unit, and the like, to manufacture the portable loading and unloading apparatus for the mobile vehicle that is portable, quickly assembled, and applicable to different environments.

The present disclosure is a portable loading and unloading apparatus for a mobile vehicle, including: a plurality of stacked bearing units, configured to bear a heavy object, where the stacked bearing units include a plurality of bearing plates; two long ramps, disposed on the stacked bearing units, where the long ramps include a plurality of ramp units; and a safety auxiliary unit, including a plurality of auxiliary plates and a plurality of side baffles, where the plurality of auxiliary plates are disposed between the two long ramps, and the side baffles are disposed on a side position of the two long ramps.

The foregoing bearing plates may be designed to have different heights. In the present disclosure, the stacked bearing units may include the plurality of bearing plates, and the stacked bearing units of different heights are formed by using the bearing plates of different heights.

An embodiment of the present disclosure further includes an adapter plate, where the adapter plate is configured to connect to a platform, to adjust a height difference between the platform and the portable loading and unloading apparatus for the mobile vehicle. The platform may be (but is not limited to) a platform of a railway station, a railcar of a railway platform, a large flatbed trailer, a flatbed dock of a heavy equipment transport vehicle. The adapter plate includes a buckling plate and a platform ramp plate, where the platform ramp plate is disposed on the platform, and the buckling plate is connected in series to the platform ramp plate and the ramp units by using a buckle. The buckle may be a pyramid-shaped buckle (but this is not limited thereto). When two units are assembled, after a button lock is inserted into a corresponding hole position, the two units can be combined after a single body performs a slight angular rotation. This method can be used to reduce duration of an assembly operation and reduces a complexity degree of the assembly.

In the present disclosure, at least one steering base is further included. Two ends of the steering base have a feature of a trapezoid-shaped structure (but are not limited to a trapezoid shape), and the steering base has a design pattern of a long segment and a short segment that are of different lengths. In embodiments of the present disclosure, the steering bases are disposed between adjacent stacked bearing units and are connected to the adjacent stacked bearing units by using a pin structure. The plurality of steering bases are disposed between the adjacent stacked bearing units in descending order of lengths. The long segment is a steering outer side and the short segment is a steering inner side, so that after the apparatus is assembled, because there is a length difference between the inner side and the outer side, a steering effect is achieved. In this way, a steering function can be generated for the portable loading and unloading apparatus for the mobile vehicle by using the long segment and the short segment of each of the steering bases (having different lengths). In addition, an upper side and a lower side of each steering base have different colors. In the present disclosure, groups of pairing colors are used to avoid misplacement of the steering bases, and the group of pairing colors are used to manage and distinguish a combination pattern of a match between the long segment and the short segment. Further, when the steering bases are disposed, the long segments and the short segments of the steering bases are disposed in the same color, so that a problem of misuse and a problem of mistaken disposition can be avoided.

In the foregoing embodiment, a plurality of steering bridging plates are further included, where the plurality of steering bridging plates are disposed between adjacent ramp units, to avoid a case in which due to the steering function, hazards are caused by gaps generated between adjacent ramp units.

The foregoing brief descriptions, the following detailed descriptions, and the accompanying drawings are all intended to further describe the means and methods used by the present disclosure to achieve intended objectives and effects that are achieved. Other objectives and advantages related to the present disclosure are described in the following descriptions and the accompanying drawings.

### BRIEF DESCRIPTION OF DRAWINGS

FIG. 1 is a schematic diagram of a portable loading and unloading apparatus for a mobile vehicle according to the present disclosure.

FIG. 2 is a schematic diagram of stacked bearing units of different heights according to the present disclosure.

FIG. 3 is a schematic diagram of a ramp unit according to the present disclosure.

FIG. 4 is a schematic diagram of an auxiliary plate and a side baffle according to the present disclosure.

FIG. 5 is a schematic diagram of a buckling plate and a platform ramp plate according to the present disclosure.

FIG. 6 is a schematic diagram of a steering base according to the present disclosure.

FIG. 7 is a schematic diagram of a steering bridging plate according to the present disclosure.

### DETAILED DESCRIPTION OF THE INVENTION

The following describes implementations of the present disclosure by using particular and specific embodiments, and a person skilled in the art may easily understand other advantages and effects of the present disclosure according to content disclosed in this specification.

A main idea of the present disclosure is disassembling an apparatus into a plurality of module units, so that a needed loading and unloading apparatus can be stacked according to a requirement of a field of view, and a portable loading and unloading apparatus for a mobile vehicle that is independent and portable, having an adjustable height, and having a large support area and a steering function is constructed. A main body of the present disclosure is based on stacked bearing units and ramp units, so that a ramp body having a height and a length that meet an on-site requirement can be stacked according to a requirement of a (military) task field. In addition, with a design of additional elements such as steering bases, steering bridging plates, auxiliary plates, side baffles, and adapter plates, an apparatus body can have a plurality of functions and use safety is improved.

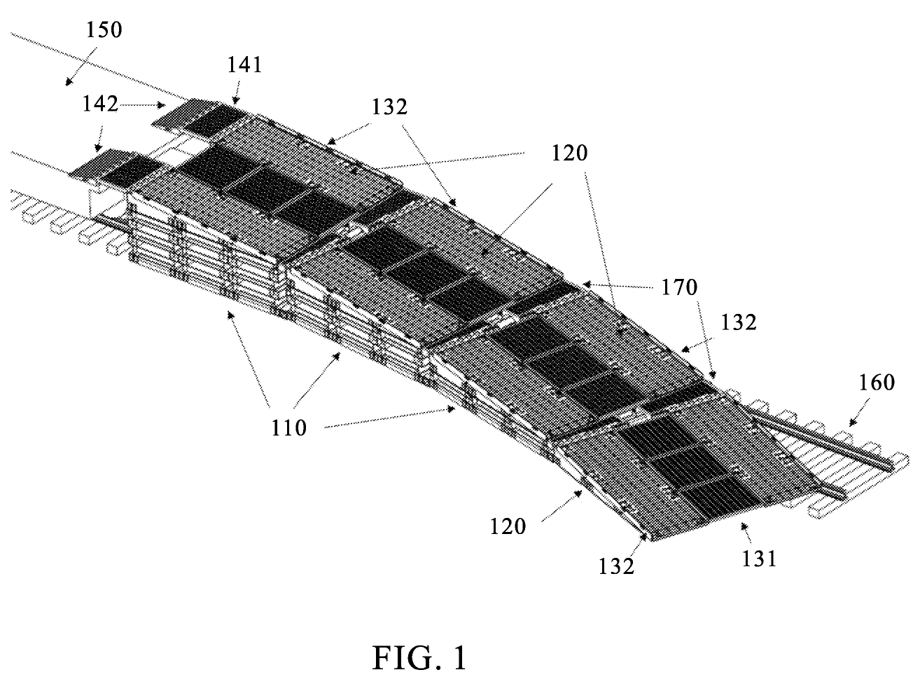

Referring to FIG. 1, FIG. 1 is a schematic diagram of a portable loading and unloading apparatus for a mobile vehicle according to the present disclosure. As shown in the figure, the present disclosure provides the portable loading and unloading apparatus for the mobile vehicle, including: a plurality of stacked bearing units 110, configured to bear a heavy object, where the stacked bearing units 110 include a plurality of bearing plates, and the stacked bearing units 110 of different heights are formed by using bearing plates of different heights; two long ramps, disposed on the stacked bearing units 110, where the long ramps include a plurality of ramp units 120; a safety auxiliary unit, including a plurality of auxiliary plates 131 and a plurality of side baffles 132, where the plurality of auxiliary plates 131 are disposed between the two long ramps, and the side baffles 132 are disposed on a side position of the two long ramps; and an adapter plate, where the adapter plate includes a buckling plate 141 and a platform ramp plate 142, and the adapter plate is configured to connect to a platform 150, to adjust a height difference between the platform 150 and the portable loading and unloading apparatus for the mobile vehicle. In this embodiment, the portable loading and unloading apparatus for the mobile vehicle is mounted on a rail track 160, and the platform 150 is a platform for a flatcar on the railway track.

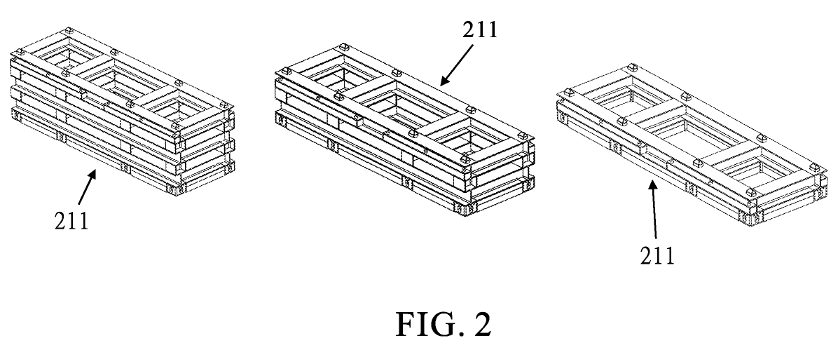

Referring to FIGS. 1 and 2, FIG. 2 is a schematic diagram of stacked bearing units of different heights according to the present disclosure. As shown in the figure, a core structure of the apparatus in the present disclosure includes the stacked bearing units 110 of different heights, and these stacked bearing units 110 are modularly formed by using bearing plates 211 of different heights. In this embodiment, three types of the bearing plates 211 of different heights are used (but this is not limited thereto). According to a case in which the stacked bearing units 110 of different heights are formed by using the bearing plates 211 of different heights, with such a modularized design, the apparatus in the present disclosure can adapt to height requirements of different types of platforms 150 (for example, the platform 150 may be one of the following docks: a dock of a low-chassis flatbed-type truck, a flatbed-type dock of a high-chassis container transport vehicle, a platform of a railway station, or a flatbed-type dock of a train). In addition, the bearing plates 211 are made of high-strength materials, which can provide an excellent bearing capability. In this embodiment, apparatus elements are all made of aluminum alloys AL6061 and AL5052 (but this is not limited thereto). The alloy is based on aluminum, and magnesium and silicon are added as main alloy elements. After solution heat treatment is performed, the alloy has excellent strength and anti-fatigue performance, and has features such as a light weight and anti-corrosion. Therefore, each bearing plate 211 can be placed on a military lorry, and a placement position is well planned. The apparatus in the present disclosure can be quickly transported to a specified location in a most convenient carrying manner, to complete a loading and unloading operation on a large vehicle.

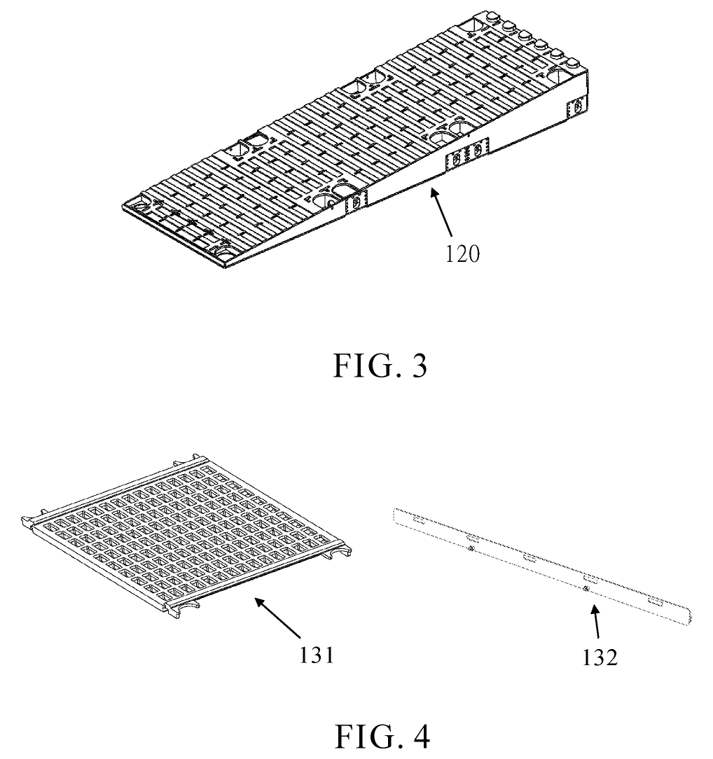

Referring to FIGS. 1 and 3, FIG. 3 is a schematic diagram of a ramp unit according to the present disclosure. As shown in the figure, in this embodiment, the plurality of ramp units 120 are disposed on the stacked bearing units 110. These ramp units 120 form two stable long ramps on the stacked bearing units 110 (the last ramp unit 120 is disposed on the ground). An anti-slip pattern design is applied to surfaces of the ramp units 120, to effectively prevent the vehicle from slipping during traveling, and provide additional safety assurance especially when an angle of the ramp is relatively large. Heights and lengths of the long ramps formed by the ramp units 120 may be adjusted according to a use requirement, to adapt to different site conditions.

Referring to FIGS. 1 and 4, FIG. 4 is a schematic diagram of an auxiliary plate and a side baffle according to the present disclosure. As shown in the figure, in this embodiment, to further improve safety and stability of the apparatus of the present disclosure, the apparatus is equipped with the safety auxiliary unit, including the auxiliary plates 131 disposed between the two long ramps and the side baffles 132 disposed on two sides of a ramp of the portable loading and unloading apparatus for the mobile vehicle. A driving view of a large vehicle is affected due to a vehicle model factor. Although a command person directs the large vehicle when the large vehicle gets on or off the platform 150, there is a significant height difference between the platform 150 and the ramp relative to the ground. Once the large vehicle deviates from a lane in a traveling process, a serious accident may be caused. Therefore, in the present disclosure, the auxiliary plates 131 are disposed at the center between the two long ramps, and the side baffles 132 are designed at an edge of an outer side of each of the two long ramps. When the large vehicle slightly deviates from the ramp lane, the auxiliary plates 131 and the side baffles 132 can serve as barriers, providing the driver with an opportunity to promptly correct the vehicle’s direction and providing an additional safety protection mechanism.

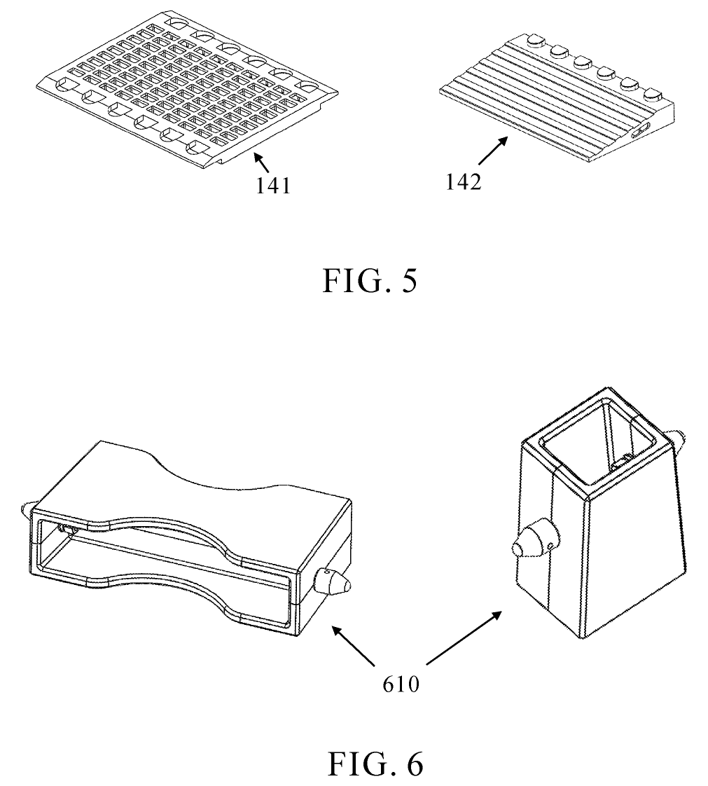

Referring to FIGS. 1 and 5, FIG. 5 is a schematic diagram of a buckling plate and a platform ramp plate according to the present disclosure. As shown in the figure, in this embodiment, to resolve the problem of a height difference between the portable loading and unloading apparatus for the mobile vehicle provided in the present disclosure and the platform 150, the adapter plate is designed in the present disclosure. The adapter plate includes the buckling plate 141 and the platform ramp plate 142, where the platform ramp plate 142 is disposed on the platform 150. The platform 150 is quickly buckled by using specially made buckles. The buckling plate 141 is configured to connect the platform ramp plate 142 with the ramp units 120 at an uppermost end of the portable loading and unloading apparatus for the mobile vehicle provided in the present disclosure. In this way, smooth transition between the platform 150 and the portable loading and unloading apparatus for the mobile vehicle provided in the present disclosure is implemented, thereby reducing difficulty caused by the height difference during operation, and improving smoothness of vehicle movement.

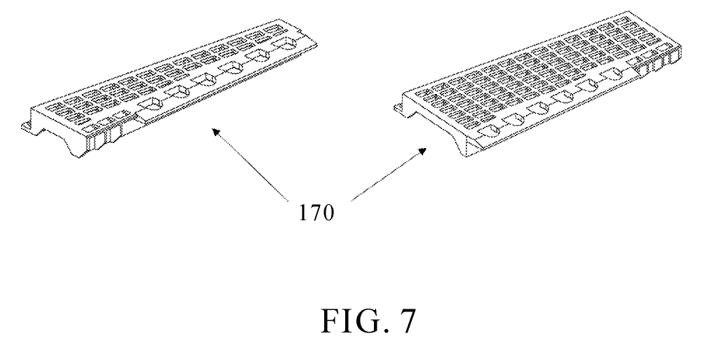

Referring to FIGS. 1, 6, and 7, FIG. 6 is a schematic diagram of a steering base according to the present disclosure, and FIG. 7 is a schematic diagram of a steering bridging plate according to the present disclosure. As shown in the figure, in this embodiment, a modularization concept is also sufficiently applied to the design of the steering function. The steering function is formed by means of a mutual match between module units of steering bases 610 and module units of steering bridging plates 170. The steering bases 610 are disposed between adjacent stacked bearing units 110, and provide a flexible direction adjustment function. Each of the steering bases 610 is divided into two segments: a long segment and a short segment (but this is not limited thereto). The long segment is a steering outer side and the short segment is a steering inner side, so that the inner side and the outer side of the portable loading and unloading apparatus for the mobile vehicle provided in the disclosure have a length difference, and consequently, a steering effect is achieved. A skillful design of the steering bases 610 is that the steering bases 610 can be used for both left steering and right steering, so that a quantity of modules that needs to be prepared is reduced. In addition, groups of pairing colors are used (an upper side and a lower side of each steering base 610 have different colors. When the steering bases 610 are disposed, the long segments and the short segments of the steering bases 610 are disposed in the same color) to manage and distinguish a combination pattern of a match between the long segments and the short segments, so that the problem of misuse when a module is generally used is resolved. To further enhance structural stability, in the apparatus, the steering bridging plates 170 are disposed between adjacent ramp units 120. The steering bridging plates 170 can firmly connect two ramp units 120, which can increase strength of an entire structure. Each of the steering bridging plates 170 is also designed as a long segment and a short segment (but is not limited thereto), to fill gaps caused by the steering bases 610, so that traveling experience of the (military) mobile vehicle is relatively smooth.

The present disclosure provides the portable loading and unloading apparatus for the mobile vehicle, which is highly efficient, safe, and flexible. The portable loading and unloading apparatus for the mobile vehicle includes the plurality of stacked bearing units, which are formed by stacking the plurality of bearing plates, and a stacking height can be adjusted and selected according to a requirement to adapt to loading and unloading requirements of different vehicles. The plurality of ramp units are disposed on the stacked bearing units, to form the two stable long ramps, which facilitates the mobile vehicle to smoothly get on or off the platform. In addition, to further improve safety, the apparatus is equipped with the safety auxiliary unit, including the auxiliary plates disposed between the two long ramps, to enhance stability, and the side baffles located on two sides of the ramp, to effectively prevent the mobile vehicle from sliding down. To resolve the height difference problem between the platform and the portable loading and unloading apparatus for the mobile vehicle provided in the present disclosure, the adapter plate is designed in the present disclosure. The adapter plate includes the buckling plate and the platform ramp plate. The buckling plate can be quickly buckled with the buckle, to ensure that the platform is stably connected in series to the ramp units, thereby implementing quick assembly and disassembly, and further improving convenience and safety of a loading and unloading operation. To satisfy requirements of various sites and operation directions, the portable loading and unloading apparatus for the mobile vehicle provided in the present disclosure is provided with the steering bases between adjacent stacked bearing units. The steering bases are of a double-sided design, and there are different color markings on two sides, to help a user quickly identify a use status or a direction. In addition, the steering bridging plates are disposed between adjacent ramp units, to implement a structural connection and enhance stability, improve a bearing capability, and satisfy more application scenarios. Because a design core of the portable loading and unloading apparatus for the mobile vehicle provided in the present disclosure is modularization, lightweight, and high safety, and the portable loading and unloading apparatus for the mobile vehicle can adapt to various loading and unloading operation environments, the portable loading and unloading apparatus for the mobile vehicle provided in the disclosure is a high-efficient and reliable loading and unloading solution for a large mobile vehicle.

The foregoing embodiments are merely used for exemplary description of features and effects of the present disclosure, but are not used for limiting the scope of the substantial technical content of the present disclosure. A person skilled in the art can make modifications and variations to the foregoing embodiments without departing from the spirit and scope of the present disclosure. Therefore, the protection scope of the present disclosure shall be set forth in the appended claims.

What is claimed is:

1. A portable loading and unloading apparatus for a mobile vehicle, comprising:
a plurality of stacked bearing units, configured to bear a heavy object, wherein the stacked bearing units comprise a plurality of bearing plates;
two long ramps, disposed on the stacked bearing units, wherein the long ramps comprise a plurality of ramp units; and
a safety auxiliary unit, comprising a plurality of auxiliary plates and a plurality of side baffles, wherein the plurality of auxiliary plates are disposed between the two long ramps, and the side baffles are disposed on a side position of the two long ramps.

2. The portable loading and unloading apparatus for the mobile vehicle according to claim 1, wherein the plurality of stacked bearing units are formed of different heights by using bearing plates of different heights.

3. The portable loading and unloading apparatus for the mobile vehicle according to claim 1, further comprising an adapter plate, wherein the adapter plate is configured to connect to a platform, to adjust a height difference between the platform and the portable loading and unloading apparatus for the mobile vehicle.

4. The portable loading and unloading apparatus for the mobile vehicle according to claim 3, wherein the adapter plate comprises a buckling plate and a platform ramp plate.

5. The portable loading and unloading apparatus for the mobile vehicle according to claim 4, wherein the buckling plate is connected in series to the platform ramp plate and the ramp units by using a buckle.

6. The portable loading and unloading apparatus for the mobile vehicle according to claim 5, wherein the platform ramp plate is disposed on the platform.

7. The portable loading and unloading apparatus for the mobile vehicle according to claim 1, further comprising a plurality of steering bases, wherein the steering bases are disposed between adjacent stacked bearing units.

8. The portable loading and unloading apparatus for the mobile vehicle according to claim 7, wherein groups of pairing colors are used by the steering bases to avoid misplacement of the steering bases.

9. The portable loading and unloading apparatus for the mobile vehicle according to claim 7, further comprising a plurality of steering bridging plates, wherein the steering bridging plates are disposed between adjacent ramp units.
